(19) United States
(12) Patent Application Publication
(10) Pub. No.: US 2005/0027886 A1
(43) Pub. Date: Feb. 3, 2005

(54) Method and system for transforming non-web service enabled providers of functional services

(75) Inventors: Joe Putnam, Cedar Rapids, IA (US); Kelly J. Ungs, Marion, IA (US)

Correspondence Address: SIMMONS, PERRINE, ALBRIGHT & ELLWOOD, P.L.C., THIRD FLOOR TOWER PLACE, 22 SOUTH LINN STREET, IOWA CITY, IA, 52240, US

(73) Assignee: Intermec IP Corp.

(21) Appl. No.: 10/884,161

(22) Filed: Jul. 2, 2004

Related U.S. Application Data
(60) Provisional application No. 60/484,975, filed on Jul. 3, 2003.

(51) Int. Cl. G06F 15/16

(52) U.S. Cl. 709/247; 709/218

(57) ABSTRACT

A system and method for transforming a plurality of existing non-web services enabled functional services so as to appear to a web services consumer and to a UDDI server to be a plurality of individual web services. The system includes a web services transformer which acts as a translator and a proxy server for the plurality of non-web services enabled functional services.

### CROSS-REFERENCE TO RELATED APPLICATIONS

This application claims the benefit under 35 U.S.C. 119(e) of Provisional Application No. 60/484,975 filed on Jul. 3, 2003, by the same two inventors as in this application.

### FIELD OF THE INVENTION

The present invention relates to computer networks and more particularly to a method and system for transforming non-web services enabled providers of a service so as to contribute to provisioning of such service to web services consumers.

### BACKGROUND OF THE INVENTION

In the past, if a particular service were to be provided to a web services consumer, the provider of such service would have to be web services enabled.

More and more services are becoming available which are written to the web services standard. In many situations, it is not particularly difficult to create a new service which is intended from the outset to be a web service enabled provider of service.

However, numerous services exist, such as proprietary services and functions and services which were previously written to an older, less ubiquitous standard. With the current paradigm, these non-web service enabled providers of services would need to be re-written so as to comply with the new web services standard. However, considerable expense can be expected to be incurred in upgrading these existing services so they can individually operate as service providers to web service consumers.

Consequently, there exists a need for improved systems and methods for transforming existing web services or transforming new services written to an old or proprietary standard, without the concomitant increases in inefficiencies of converting such services to be web services enabled service providers.

### SUMMARY OF THE INVENTION

It is an object of the present invention to provide a system and method for transforming non-web services enabled services to web services enabled service providers in an efficient manner.

It is a feature of the present invention to utilize a common transformer which translates messages between the non-web services enabled service provider and a web services consumer.

It is an advantage of the present invention to achieve improved efficiency in transforming non-web services enabled service providers so as to be capable of providing, with the help of the web services transformer, services to a web services consumer.

The present invention is a system and method for transforming non-web services enabled service providers, which is designed to satisfy the aforementioned needs, provide the previously stated objects, include the above-listed features, and achieve the already articulated advantages. The present invention is carried out in an “individual software conversion-less system” in a sense that the ordinary effort associated with individually converting a plurality of non-web services enabled services to a plurality of services which are capable of providing service to a web services consumer, has been greatly reduced.

### BRIEF DESCRIPTION OF THE DRAWINGS

The invention may be more fully understood by reading the following description of the preferred embodiments of the invention, in conjunction with the appended drawings wherein:

FIG. 1 is a simplified view of a system of the present invention, where a common web services transformer is coupled to a plurality of non-web services compliant functional services.

FIG. 2 is a more detailed description of the web services transformer of the present invention.

### DETAILED DESCRIPTION

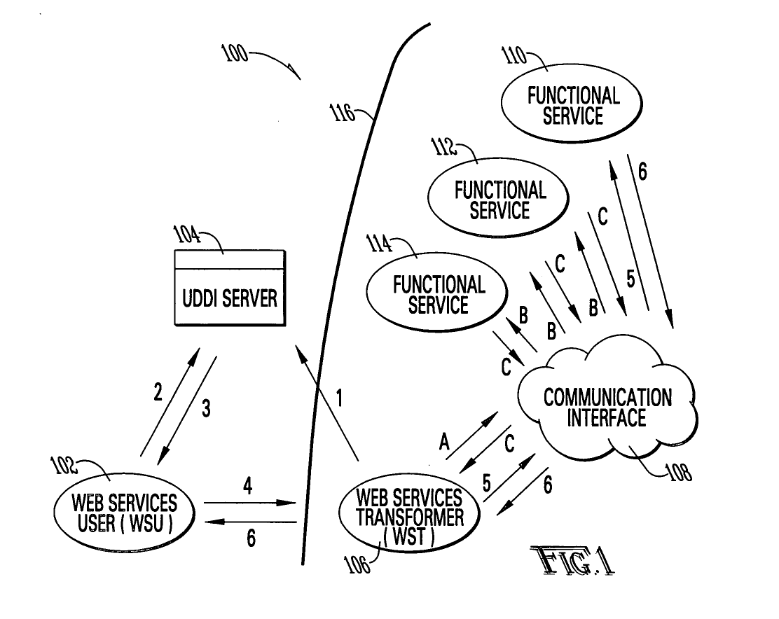

Now referring to the drawings wherein like numerals refer to like matter throughout, and more specifically referring to FIG. 1, there is shown a system of the present invention generally designated 100, including a web services user 102 (WSU), a universal description discovery and integration (UDDI) server 104, a web services transformer 106 (WST), a common communications interface 108 and non-web services enabled functional services 110, 112 and 114, which are depicted as being protected in a well-known manner by a firewall 116.

In general, the system 100 functions, in many ways, similar to prior art web services systems with a few exceptions.

WSU 102 is the end user or consumer of web services, which may be an individual at home with their personal computer (PC). Of course, many other examples of WSUs exist. The WSU 102 communicates with the UDDI server 104, as is done in the prior art. The WST 106 appears to the UDDI server 104 and the WSU 102 to be a plurality of typical self-contained individual web services. However, WST 106 is in fact a front-end translator and proxy for a network of non-web services enabled functional services 110 and 112. As such, the WST 106 transforms a plurality of non-web services enabled functional services to a plurality of virtual web services which appear to be independent, self-contained web services which are individually fully compliant with one or more web services industry standards employed by the WSU 102 and the UDDI server 104. It should be noted UDDI server 104 can be any functionally equivalent type of server irrespective of the details of whatever standard it employs.

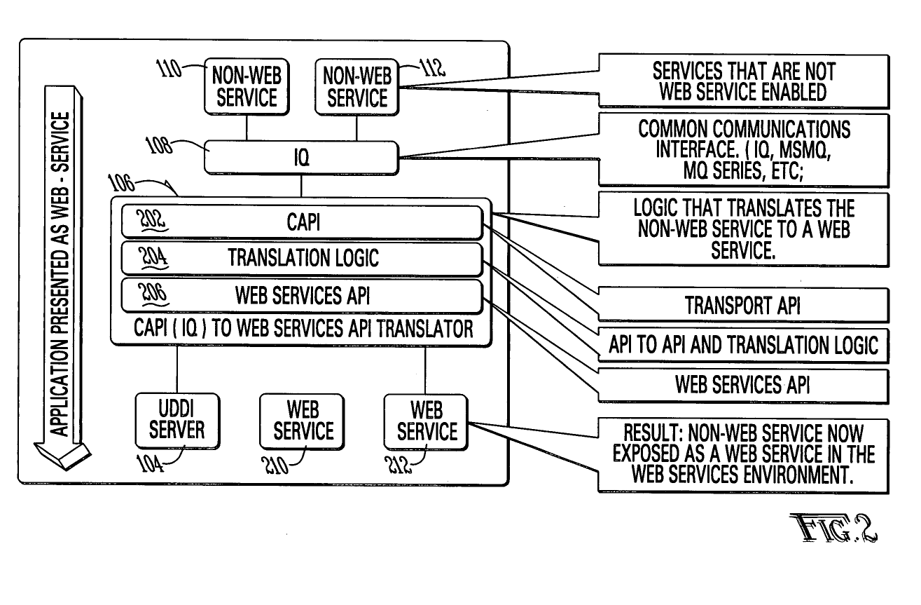

A more detailed understanding of a particular embodiment of the present invention can be achieved by now referring to FIG. 2, which generally shows a more detailed view of the system of FIG. 1, without the WSU 102. The WST 106 is shown in much more detail and includes a common application programming interface (CAPI) 202, which functions as a transport application programming interface. Translation logic 204 performs the function of an application programming interface (API) to API translation. A web services API is then provided. In combination, CAPI 202, translation logic 204, and Web Services API 206 perform all the necessary functions to make non-web enabled functional services 110 and 112 to appear to a WSU 102 (FIG. 1) as virtual web services 210 and 212. It should be understood that the precise definitions and code for the above components of the WST 106 will need to be custom made for each application or for each non-web services enabled functional service. To the extent there are similarities in the non-web services enabled functional services, there preferably can be economic benefit in consolidating multiple non-web services enabled functional services with one WST 106. Also, the Web services API 206 is preferably largely well defined by similar prior art web services APIs.

In operation, the system shown in FIGS. 1 and 2 might function as follows:

Referring first to FIG. 1, the WST 106 requests information about all available services (see line A). The request is forwarded from common communication interface 108 (see line B) to the non-web services enabled functional services 110 and 112. Functional services 110 and 112 respond (see line C).

Now referring more to FIG. 2, it is the CAPI 202 that communicates with non-web services enabled functional services 110 and 112 to determine what functions they can provide. CAPI 202 communicates first with non-web services enabled functional services 110 and 112 via a common communications interface (lines A and C), which could be a proprietary interface or an industry standard interface, as the case may be. Common communication interface 108 then communicates with the non-web services enabled functional services 110 and 112 (see lines B and C). Once this information is known to WST 106, then translation logic 204 is the logic which translates the peculiar or proprietary definition of the non-web services enabled functional service into a more standardized format. Then, Web Services API 206 provides the final layer to make the service into virtual web services which appear to the WSU 102 and UDDI sever 104 as independent, self-contained web services enabled web services.

WST 106 then sends notification to the UDDI sever 104 that it has functional services 110 and 112 available. These functions are registered with the UDDI server 104, and the requirements for using these functions are also registered (see line 1).

Now the WSU 102, who is desirous of consuming some web services, registers with the UDDI server 104 and requests functional service 110, for example (see line 2). UDDI server 104 responds to WSU 102 with the location of functional service 110 and with the requirements for using that function (see line 3). Next, the WSU 102 contacts the WST 106 (because the location given by UDDI server 104 was a location of WST 106) and requests functional service 110. A negotiation which is common between web services consumers and web services providers will typically occur (see line 4). At this point, the request shown by line 4 is a request in compliance with one or more web services industry standards. The WST 106 passes the request via common communication interface 108 to functional service 110 (see line 5). At this point, the request is NOT fully compliant with web services industry standards. Then, functional service performs the requested service and provides a response (shown in lines 6 coupled to common communication interface 108). At this stage, the response from functional service 110 is not fully compliant with all the requisite web services standards.

The response is then received by CAPI 202, translated by translation logic 204, and made fully web services compatible by web services API 206. At this point, the response is sent (in compliance with the requisite web service standards) to WSU 102 (see the last line 6), and the WSU 102 has had its request met, and WSU 102 is unaware that the ultimate provider of the requested service was not an independent self-contained web service.

Throughout this description, numerous references are made to “web services”, which is a well-known term which is understood in the industry to describe services which are in compliance with one or more predetermined published industry standards for providing services over the web. One example of such an industry standard is the UDDI standard which is maintained by the OASIS, an international standards setting organization. Other published industry standards exist and are expected to be promulgated in the future by OASIS and other organizations. It is the intention of the present invention to apply to any such web services standard.

It is thought that the method and apparatus of the present invention will be understood from the foregoing description and that it will be apparent that various changes may be made in the form, construct steps, and arrangement of the parts and steps thereof, without departing from the spirit and scope of the invention or sacrificing all of their material advantages. The form herein described is merely a preferred exemplary embodiment thereof.

1. A system for provisioning non-web services enabled functional services as web services, the system comprising:
a plurality of non-web services enabled functional services which are written to a standard which is not compliant with a web services industry standard; and,
a web service transformer, coupled to said plurality of non-web services enabled functional services, said web service transformer acts as a translator and as a proxy server for said plurality of non-web services enabled functional services, so that said plurality of non-web services enabled functional services are made available as web services to remote web users via an internet connection.

2. A system of claim 1 wherein said web service transformer further comprises:
an application programming interface for communication with said plurality of non-web services enabled functional services; and transforming said plurality of non-web services enabled functional service to web services made available to remote users.

3. A system of claim 2 wherein said application programming interface further comprises discrete application programming interfaces for:
communication with said plurality of non-web services enabled functional services;
translation of said plurality of non-web services enabled functional services to an intermediate format which still is not web services enabled; and
creation of virtual web services from said intermediate format.

4. A system of claim 3 wherein said plurality of non-web services enabled functional services communicate over a common communication interface.

5. A system of claim 4 wherein said common communication interface does not use a TCP/IP communication protocol.

6. A system of claim 5 further comprising a UDDI sever which is configured to provide remote users with address information for virtual web services which correspond to said plurality of non-web services enabled functional services.

7. A method of utilizing services from a non-web services enabled functional service, comprising the steps of:
providing a plurality of non-web services enabled functional services;
communicating with said plurality of non-web services enabled functional services using a common communication interface;
transforming said plurality of non-web service enabled functional services into a plurality of virtual web services;
communicating address information for said plurality of virtual web services with a server configured to provide web service address information to numerous users upon request; and
accessing one of said plurality of virtual web services using said web service address information.

8. A method of claim 7 wherein said step of transforming said plurality of non-web services enabled functional services further comprises the steps of:
translating said plurality of non-web services enabled functional services to a plurality of intermediate services utilizing a single predetermined standard which is not web services enabled; and,
converting said plurality of intermediate services utilizing a predetermined standard to a plurality of virtual web services.

9. A method of obtaining web service comprising the steps of:
providing to a remote user access to a universal description discovery and integration (UDDI) server for accessing address information for web services;
sending a web services request to an address for a web transformer server which has been previously provided by said UDDI server and where said web transformer server does not perform the entire web services request;
receiving said web services request and converting said request to a non-web services request configured to be used by a non-web services enabled server;
forwarding said non-web services request to said non-web services enabled server on a communication interface;
processing said non-web services request to generate a request response;
forwarding the request response to said web transformer server and generating in response thereto, a web services response; and
forwarding said web services response to said remote user.

10. A method of claim 9 wherein said step of converting said request to a non-web services request further comprises:
translating said request to an intermediate request in an intermediate non-web services format using a single application programming interface for a plurality of different types of requests; and
converting said intermediate request to said non-web services request.

11. A method of claim 10 wherein said step of forwarding said non-web services request to said non-web services enabled server is done on a common communications interface.

12. A method of claim 11 wherein said common communications interface is an IQ interface.

13. A method of claim 11 wherein said common communication interface is an MSMQ interface.

14. A method of claim 11 wherein said step of converting said intermediate request to said non-web services request further comprises using a custom application programming interface to transform information from a non-web services format of the non-web services request to an intermediate request format.

15. A method of claim 14 wherein said common communications interface is an IQ interface.

16. A method of claim 14 wherein said common communications interface is an MSMQ interface.

17. A method of claim 9 wherein said step of forwarding said non-web services request to said non-web services enabled server is done on a common communications interface.

18. A method of claim 17 wherein said common communications interface is an IQ interface.

19. A method of claim 17 wherein said common communications interface is an MSMQ interface.

20. A method of claim 19 wherein said step of converting said intermediate request to said non-web services request further comprises using a custom application programming interface to transform information from a non-web services format of the non-web services request to an intermediate request format.
